(19) United States
(12) Patent Application Publication
(10) Pub. No.: US 2020/0231127 A1
(43) Pub. Date: Jul. 23, 2020

(54) A WINDSCREEN WIPER ARM

(71) Applicant: TRICO BEGIUM SA, Aubange (BE)

(72) Inventor: Guillaume Seiller, Ribeauville (FR)

(21) Appl. No.: 16/641,740

(22) PCT Filed: Aug. 25, 2017
(86) PCT No.: PCT/EP2017/071425

§ 371 Date: Feb. 25, 2020

(51) Int. Cl. B60S 1/52; B60S 1/34; B60S 1/38

(52) U.S. Cl. CPC B60S 1/524; B60S 1/3853; B60S 1/3429

(57) ABSTRACT

A windscreen wiper arm, particularly for automobiles, is provided. The windscreen wiper arm is, at one end thereof, arranged to be pivotally connected to a mounting head mounted on a drive shaft and, at another end thereof, arranged to be pivotally connected to an elongated wiper blade to be placed in abutment with a windscreen to be wiped. The windscreen wiper arm can oscillate to-and-from between a first reversal position and a second reversal position. The windscreen wiper arm is provided with a tab extending downwardly from a top wall of the windscreen wiper arm. The tab is connected to a nozzle for spraying a washing liquid onto the windscreen to be wiped.

### BACKGROUND OF THE INVENTION

A known windscreen wiper arm may comprise a first arm member and a second arm member. The first arm member at one end thereof is pivotally connected to the mounting head by means of a pivot pin, for example in the form of a rivet. The first arm member at the other end thereof is connected to a second arm member in the form of a wiper rod, for example, wherein one end of the wiper rod extends inside the first arm member. A spring is hooked with its first end on the mounting head and with its second end on to the wiper rod in order to ensure that the wiper rod and thus the wiper blade connected thereto is pressed onto a windscreen to be wiped. In use, the shaft rotates alternately in a clockwise and in a counter-clockwise sense carrying the mounting head into rotation also, which in turn draws the arm members into rotation and by means of a connecting device (interconnecting the wiper rod and the wiper blade) moves the wiper blade.

A disadvantage of the known windscreen wiper arm is the following. In use, during each oscillatory movement of the windscreen wiper arm, rain water will be pressed against a side of the connecting device facing away from the free end of the windscreen wiper arm, as the side of the connecting device has an over pressure relative to the environment as a result of an oscillatory movement of the windscreen wiper arm. Hence, rain water accumulates at the location of the side of the connecting device resulting in the so-called “after spray” phenomenon, namely droplets of rain water being left behind on a windscreen to be wiped after each oscillatory movement of the windscreen wiper arm. Further, from a safety perspective, a time period, wherein the vision of a driver is negatively affected by washing liquid being sprayed from a nozzle near a bonnet of a vehicle onto a wiped windscreen and by the windscreen wiper arm following its oscillatory movement and wiping the washing liquid away, is considered too long. Further, washing liquid being sprayed from a nozzle near a bonnet of a vehicle reaches a limited area of the wiped windscreen, so that the windscreen wiper arm does not effectively clean the windscreen.

### SUMMARY OF THE INVENTION

It is an object of the invention to obviate these disadvantages, in the sense that at minimum costs—without using complex machinery and additional tools—windscreen wiper arms are proposed avoiding the after spray phenomenon, only affecting a driver's vision for a shorter period, and effectively cleaning the windscreen over a larger area thereof.

The present invention relates to a windscreen wiper arm, particularly for automobiles, at one end thereof arranged to be pivotally connected to a mounting head mounted on a drive shaft and at another end thereof arranged to be pivotally connected to an elongated wiper blade to be placed in abutment with a windscreen to be wiped. The windscreen wiper arm can oscillate to-and-from between a first reversal position and a second reversal position.

In the framework of the present invention, the first reversal position may be identified as a position where the windscreen wiper arm extends parallel to a windscreen to be wiped and is located near a lower edge of the windscreen to be wiped. Also, the second reversal position may be formulated as a position where the windscreen wiper arm extends also parallel to a windscreen to be wiped and is located in a central region or near a side edge of the windscreen to be wiped.

The present invention also relates to a method for manufacturing a windscreen wiper arm.

It is noted that the present invention is not restricted to automobiles, but also refers to rail coaches and other (fast) vehicles.

According to the invention, a windscreen wiper arm is characterized in that the windscreen wiper arm is provided with a tab extending downwardly from a top wall of the windscreen wiper arm. The tab is connected to a nozzle for spraying a washing liquid onto the windscreen to be wiped. Particularly, the tab extends downwardly from an exterior longitudinal edge of the top wall of the windscreen wiper arm. More in particular, the nozzle is detachably connected to the tab through a snapping connection.

A source for the washing liquid, such as a water source or reservoir, as well as an electricity source, such as a battery, are preferably located under a bonnet of the car involved.

The windscreen wiper arm at another end thereof is preferably arranged to be pivotally connected through a bayonet connection to an elongated wiper blade of the flat blade type. This wiper blade of the flat blade type is designed as a so-called “yokeless blade”, wherein no use is made of several yokes pivotally connected to each other, but the wiper blade made of an elastomer material biased by a carrier element made of band steel, for example, in the form of one longitudinal strip located in a central longitudinal groove of the wiper blade or two longitudinal strips disposed in opposite longitudinal grooves of the wiper blade. As a result, the wiper blade exhibits a specific curvature. In order to connect the wiper blade onto the windscreen wiper arm on the basis of a bayonet connection, a resilient tongue of a connecting device fixed to the wiper blade is initially pushed in against a spring force as if it were a push button and then allowed to spring back into a hole provided in the windscreen wiper arm, thus snapping, that is clipping the resilient tongue into the hole. By subsequently pushing in again the resilient tongue against the spring force, the wiper blade may be released from the windscreen arm.

In a preferred embodiment of a windscreen wiper arm in accordance with the invention, the nozzle is provided with a resilient tongue arranged to snap into a correspondingly shaped hole in the tab. Preferably, the resilient tongue is hingeable around a hinge in use facing away from the windscreen to be wiped.

In another preferred embodiment of a windscreen wiper arm according to the invention, the nozzle comprises a guiding groove for slidingly guiding the nozzle onto the tab.

In another preferred embodiment of a windscreen wiper arm in accordance with the invention, the nozzle (except for its resilient tongue) is covered by the top wall and the tab. Therefore, the nozzle for a washing liquid inside the windscreen wiper arm is protected from the environment, such as snow, ice, UV-radiation from the sun, and dust. Further, the nozzle is not visible for a driver.

In another preferred embodiment of a windscreen wiper arm according to the invention at least a part of the windscreen wiper arm is made integrally from a single sheet material. Parts of the sheet material are folded outwardly to form legs of a U-shaped cross-section of the windscreen wiper arm. At the location of its connection to the nozzle, one of the legs forms the tab. Particularly, the leg forming the tab has a larger length than the other leg of the U-shaped cross-section of the windscreen wiper arm. Hence, due to the U-shaped cross-section, the weight of the entire windscreen wiper arm is significantly reduced compared to conventional windscreen wiper arms. Further, the rigidity of the windscreen wiper arm in longitudinal direction thereof is now increased with less material (compared to the prior art).

In another preferred embodiment of a windscreen wiper arm in accordance with the invention, the nozzle comprises a spraying head detachably connected thereto, preferably through a snapping connection. Preferably, the spraying head is rotatable between a first position and a second position relative to the nozzle in order to adjust a spraying angle of the washing liquid onto the windscreen to be wiped, dependent on the length of the wiper blade, for example. In the alternative, the spraying head is stationary relative to the nozzle, i.e. no relative movement is allowed between the nozzle and the spraying head.

In another preferred embodiment of a windscreen wiper arm according to the invention, the nozzle and the spraying head are provided with mutually cooperating tooth/groove means to fixate the spraying head relative to the nozzle in the first or the second position.

The present invention also relates to a method for manufacturing a windscreen wiper arm, particularly for automobiles, at one end thereof arranged to be pivotally connected to a mounting head mounted on a drive shaft and at another end thereof arranged to be pivotally connected to an elongated wiper blade to be placed in abutment with a windscreen to be wiped. The windscreen wiper arm can oscillate to-and-from between a first reversal position and a second reversal position, characterized in that the windscreen wiper arm is provided with a tab extending downwardly from a top wall of the windscreen wiper arm. The tab is connected to a nozzle for spraying a washing liquid onto the windscreen to be wiped.

It is noted that in the invention use is made of a mounting head fixed for rotation to a shaft. The shaft is rotatable alternately in a clockwise and in a counter-clockwise sense carrying the mounting head into rotation. Thus, in turn the mounting head draws a connecting device fixed to a wiper blade into rotation and thereby moves the wiper blade. In the alternative, the mounting head is fixed for translation to a carriage. The carriage can be translated alternately in a one linear direction and in another counter linear direction carrying the mounting head into translation. The present invention can therefore be used for circular or linear movement of the mounting head.

### BRIEF DESCRIPTION OF THE DRAWINGS

The invention will now be explained in more detail with reference to figures illustrated in a drawing, wherein:

FIG. 1 is a schematic side view of a preferred embodiment of a windscreen wiper arm according to the invention together with a nozzle for spraying a washing liquid onto the windscreen to be wiped (without a windscreen wiper blade);

FIG. 2 shows a schematic perspective, exploded view of the windscreen wiper arm of FIG. 1;

FIG. 3 is a cross-sectional view of the windscreen wiper arm of FIG. 1 at the location of the interconnection between the windscreen wiper arm and the nozzle;

FIG. 4 shows a preferred embodiment of the windscreen wiper arm and the nozzle before being assembled;

FIG. 5 shows a preferred embodiment of the nozzle partly in cross-section;

FIG. 6 shows a detailed view of FIG. 5;

FIG. 7 is a cross-sectional view of the windscreen wiper arm according to another embodiment according to the invention at the location of the interconnection between the windscreen wiper arm and the nozzle;

FIG. 8 is a schematic perspective view of a wiper blade to be connected to a windscreen wiper arm of FIG. 1.

### DETAILED DESCRIPTION OF PREFERRED EMBODIMENTS

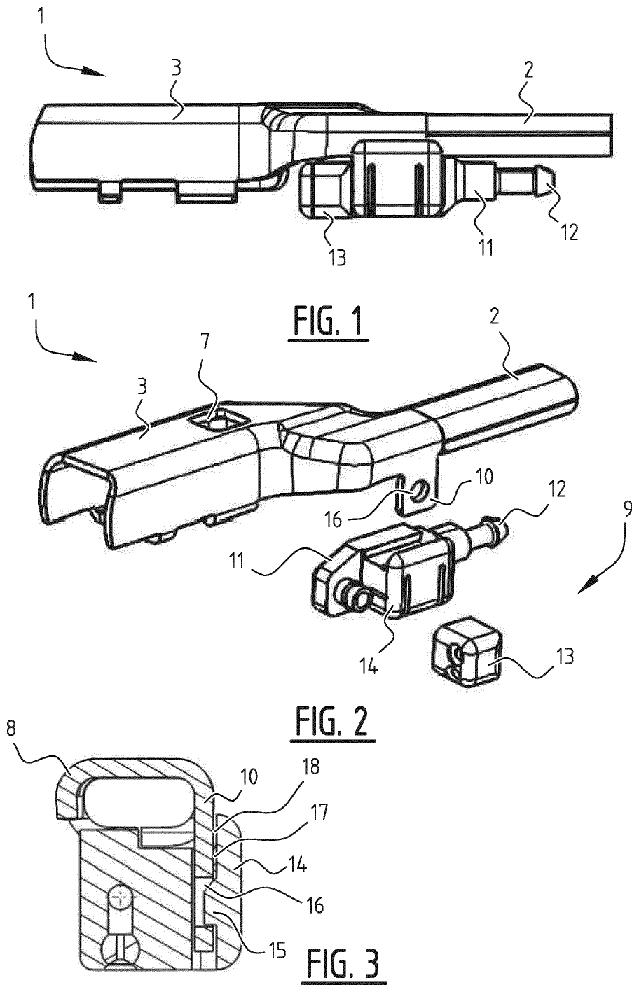

FIG. 1 shows a preferred variant of a windscreen wiper arm 1 according to the invention arranged to be connected to a mounting head (not shown) fixed for rotation to a shaft driven, via a mechanism not illustrated, by a small motor. As illustrated in FIG. 1, the windscreen wiper arm 1 according to the invention comprises a first arm member 2 supported by the mounting head or an intermediate extension or channel, as well as a second arm member or “adapter” 3 rigidly connected to the first arm member 2. The second arm member 3 in turn supports a wiper blade 4 with the help of a connecting device 5 (see FIG. 8). In this case, the first and second arm members 2, 3 are welded together. The first arm member 2 is pivotally connected to the mounting head by means of a pivot pin, for example in the form of a rivet. A spring (not shown) is hooked with its first end on the mounting head and with its second end on to the second arm member 3 in order to ensure that the second arm member 3 and thus the wiper blade 4 connected thereto is pressed onto a windscreen to be wiped. In use, the shaft rotates alternately in a clockwise and in a counter-clockwise sense carrying the mounting head into rotation also, which in turn draws the first and second arm members 2, 3 into rotation and by means of the connecting device 5 moves the wiper blade 4.

As illustrated, in interconnecting the connecting device 5 and the second arm member 3 use is made of a so-called “bayonet connection”, wherein a resilient tongue 6 of a joint part 5′ clipped onto the connecting device 5 during a sliding movement is initially pushed inwards against a spring force and is then allowed to spring back into a correspondingly shaped hole 7 of the second arm member 3, thus snapping, that is clipping the resilient tongue 6 into the hole 7. By subsequently pushing in again the resilient tongue 6 against the spring force (as if it were a push button), the connecting device 5 together with the wiper blade 4 may be released from the windscreen wiper arm 1. The wiper blade 4 is of the so-called “flat blade type”, wherein the wiper blade 4 includes at least one longitudinal groove, in which groove a longitudinal strip of a carrier element is disposed in order to bias the wiper blade 4.

With reference to FIGS. 1, 2 and 3, the second arm member 3 is made integrally from a single sheet material. Portions of the sheet material are folded outwardly to form legs 8 of a U-shaped cross-section of the second arm member 3. At the location of an interconnection between the second arm member 3 and a nozzle 9 for spraying a washing liquid onto a windscreen to be wiped, one of the legs 8 forms a downwardly extending tab 10 having a larger length than the other leg 8 of the U-shaped cross-section (see FIG. 3).

As illustrated in FIG. 2, the nozzle 9 is composed of a nozzle body 11 having a conduit 12 arranged to be connected to a reservoir for the washing liquid, as well as a spraying head 13 for spraying the washing liquid onto a windscreen to be wiped. The nozzle body 11 is detachably connected, i.e. snapped or clipped, to the tab 10 in the following manner. The nozzle 9 is provided with a resilient tongue 14 having an inwardly extending protrusion 15 (see FIG. 3) arranged to snap into a correspondingly shaped hole 16 in the tab 10. As shown in FIG. 3, the resilient tongue 14 is hingeable around a hinge 17 in use facing towards the windscreen to be wiped. During a sliding movement of the nozzle body 11 in upward direction the resilient tongue 14 of the nozzle body 11 is initially pushed outwards against a spring force and is then allowed to spring back with its protrusion 15 into the correspondingly shaped hole 16 of the tab 10, thus snapping, that is clipping the resilient tongue 14 into the hole 16. By subsequently sliding the nozzle body 11 in downward direction (and opening the tongue 14 to the outside) against the spring force, the protrusion 15 of the resilient tongue 14 is removed from the hole 16 of the tab 10, so that the nozzle body 11 together with the spraying head 13 may be released from the second arm member 3. In order to facilitate mounting of the nozzle body 11 onto the tab 10, the nozzle body 11 comprises a guiding groove 18 for slidingly guiding the nozzle body 11 onto the tab 10. The guiding groove is formed by two opposing vertical ribs, as depicted.

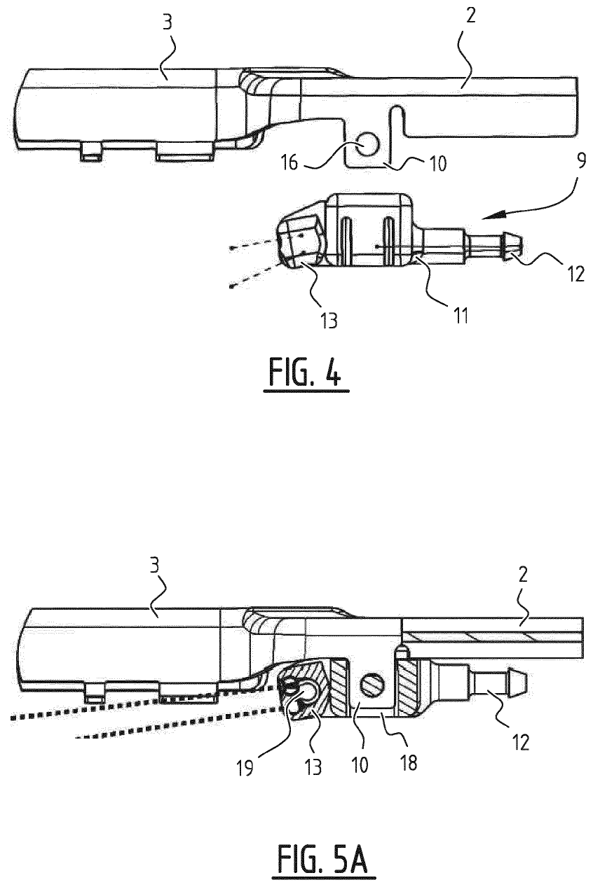

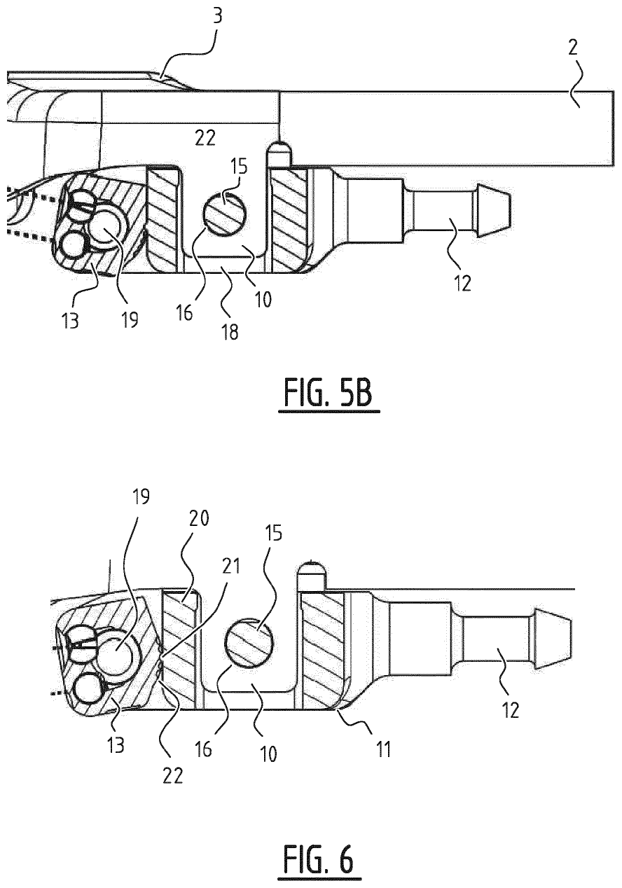

With reference to FIGS. 4, 5 and 6, the spraying head 13 is rotatable along a pivot axis 19 extending laterally outwardly from the nozzle body 11 between a first position (see top FIG. 5) and a second position (see bottom FIG. 5) relative to the nozzle body 11 in order to adjust a spraying angle of the washing liquid onto the windscreen to be wiped. A wall 20 of the nozzle body 11 comprises a tooth 21 cooperating with grooves 22 on the spraying head 13 (see FIGS. 5 and 6) in order to fixate the spraying head 13 relative to the nozzle 9 in the first position or the second position.

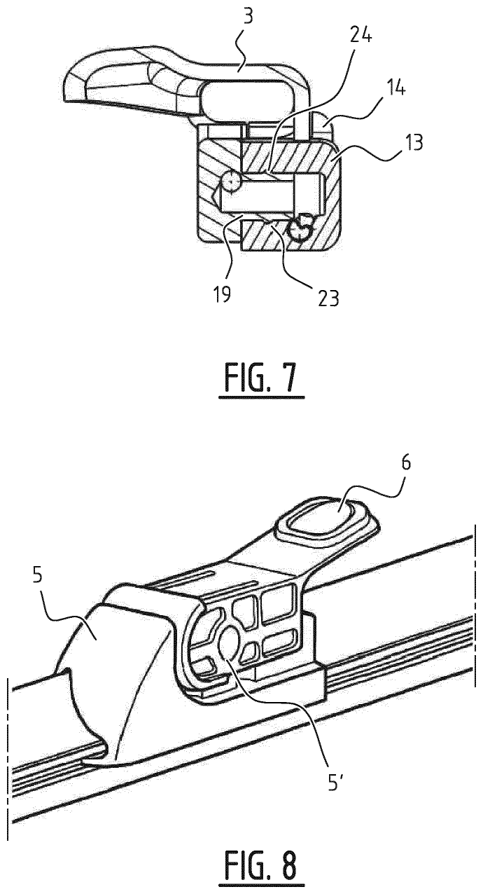

FIG. 7 relates to another preferred embodiment, wherein the spraying head 13 is blocked against any rotation due to protrusions 23 on the pivot axis 19 engaging into correspondingly shaped recesses 24 on an inner side of the spraying head 13. The combination of the protrusions 23 and the recesses 23 also have a sealing effect against any leakages.

The invention is not restricted to the embodiment shown, but also extends to other preferred embodiments falling within the scope of the appended claims.

1. A windscreen wiper arm comprising:
a first arm member arranged to be pivotally connected to a mounting head mounted on a drive shaft;
a second arm member connected to said first arm member and arranged to be pivotally connected to an elongated wiper blade to be placed in abutment with a windscreen to be wiped, wherein said windscreen wiper arm can oscillate to-and-from between a first reversal position and a second reversal position;
a tab extending downwardly from a top wall of said first arm member; and
a nozzle connected to said tab for spraying a washing liquid onto said windscreen to be wiped.

2. A windscreen wiper arm according to claim 1, wherein said tab extends downwardly from an exterior longitudinal edge of said top wall.

3. A windscreen wiper arm according to claim 1, wherein said nozzle is detachably connected to said tab through a snapping connection.

4. A windscreen wiper arm according to claim 3, wherein said nozzle is provided with a resilient tongue arranged to snap into a correspondingly shaped opening in said tab.

5. A windscreen wiper arm EWE according to claim 4, wherein said resilient tongue is hingeable around a hinge in use facing away from said windscreen to be wiped.

6. A windscreen wiper arm according to claim 1, wherein said nozzle comprises a guiding groove for slidingly guiding said nozzle onto said tab.

7. A windscreen wiper arm according to claim 1, wherein said nozzle is at least partly covered by said top wall and said tab.

8. A windscreen wiper arm according to claim 1, wherein at least a part of said windscreen wiper arm is made integrally from a single sheet material, wherein portions of said sheet material are folded outwardly to form a pair of legs of a U-shaped cross-section of said windscreen wiper arm on, and wherein, at the location of its connection to said nozzle, one of said legs forms said tab.

9. A windscreen wiper arm according to claim 8, wherein said leg forming said tab has a larger length than the other leg of said U-shaped cross-section of said windscreen wiper arm.

10. A windscreen wiper arm according to claim 1, wherein said nozzle comprises a spraying head detachably connected thereto.

11. A windscreen wiper arm according to claim 10, wherein said spraying head is detachably connected to said nozzle through a snapping connection.

12. A windscreen wiper arm according to claim 10, wherein said spraying head is rotatable between a first position and a second position relative to said nozzle in order to adjust a spraying angle of said washing liquid onto said windscreen to be wiped.

13. A windscreen wiper arm according to claim 12, wherein said nozzle and said spraying head are provided with mutually cooperating tooth/groove means to fixate said spraying head relative to said nozzle in said first or said second position.

14. A windscreen wiper arm according to claim 1, wherein said second arm member is arranged to be pivotally connected through a bayonet connection to an elongated wiper blade (4) of the flat blade type.

15. (canceled)

16. A windscreen wiper arm comprising:
an arm member having a first end and a second end, where said first end is arranged to be pivotally connected to a mounting head mounted on a drive shaft, wherein said second end is arranged to be pivotally connected to an elongated wiper blade to be placed in abutment with a windscreen to be wiped, wherein said arm member can oscillate to-and-from between a first reversal position and a second reversal position;
a tab extending downwardly from a top wall of said arm member; and
a nozzle connected to said tab for spraying a washing liquid onto said windscreen to be wiped.

17. A windscreen wiper arm according to claim 16, wherein said nozzle is provided with a resilient tongue arranged to snap into a correspondingly shaped opening in said tab.

18. A windscreen wiper arm according to claim 4, wherein said resilient tongue is hingeable around a hinge in use facing away from said windscreen to be wiped.

19. A windscreen wiper arm according to claim 16, wherein at least a part of said arm member is made integrally from a single sheet material, wherein portions of said sheet material are folded outwardly to form a pair of legs of a U-shaped cross-section of said arm member, and wherein, at the location of its connection to said nozzle, one of said legs forms said tab.

20. A windscreen wiper arm according to claim 16, wherein said nozzle comprises a spraying head detachably connected thereto.

21. A windscreen wiper arm according to claim 16, wherein said nozzle comprises a guiding groove for slidingly guiding said nozzle onto said tab.
